(19) United States
(12) Patent Application Publication
(10) Pub. No.: US 2021/0372804 A1
(43) Pub. Date: Dec. 2, 2021

(54) INFORMATION PROCESSING DEVICE, INFORMATION PROCESSING SYSTEM, PROGRAM, AND VEHICLE

(71) Applicant: TOYOTA JIDOSHA KABUSHIKI KAISHA, Toyota-shi (JP)

(72) Inventors: Tooru NAKANISHI, Nagakute-shi (JP); Tadashi YAMADA, Toyota-shi (JP); Josuke YAMANE, Nissin-shi (JP); Mitsuhiro MIURA, Toyota-shi (JP); Tomo SASAKI, Toyota-shi (JP); Tomoyuki KOZUKA, Toyota-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 17/225,714

(22) Filed: Apr. 8, 2021

(30) Foreign Application Priority Data
May 29, 2020 (JP) 2020-094750

(51) Int. Cl. G01C 21/34; G08G 1/0962; G06Q 30/02

(52) U.S. Cl. CPC G01C 21/3461; G01C 21/3415; G06Q 30/0283; G08G 1/09626

(57) ABSTRACT

An information processing device includes a control unit. The control unit acquires information related to a vehicle traveling in one area and compares the acquired information with past data in which the information and land price information are associated with each other for each area so as to estimate the land price information in the one area.

### CROSS-REFERENCE TO RELATED APPLICATION

This application claims priority to Japanese Patent Application No. 2020-094750 filed on May 29, 2020, incorporated herein by reference in its entirety.

### BACKGROUND

### 1. Technical Field

The present disclosure relates to an information processing device, an information processing system, a program, and a vehicle.

### 2. Description of Related Art

A technique for estimating land price information at a plurality of points included in a predetermined range has been known. For example, Japanese Unexamined Patent Application Publication No. 2007-122197 (JP 2007-122197 A) discloses a land price analysis system. Such a land price analysis system stores land price information at a plurality of points included in a displayed map, and receives a designation of a land price analysis target range having a predetermined size and including the points to be subjected to the land price analysis on the map. The land price analysis system calculates the actual prices at the points included in the land price analysis target range by correcting the land price information at the points included in the designated land price analysis target range in accordance with a predetermined correction standard.

### SUMMARY

The main purpose of the land price analysis system according to the related art is to enable easy and low-cost analysis of actual land prices of the points included in a designated range having a certain size. In JP 2007-122197 A in which such a land price analysis system is disclosed, it is not sufficiently considered to estimate land price information based on vehicles traveling in one area. Thus, it has been difficult to accurately estimate land price information in accordance with vehicles traveling in one area.

An object of the present disclosure made in view of such circumstances is to make it possible to accurately estimate land price information in accordance with vehicles traveling in one area.

An information processing device according to an embodiment of the present disclosure includes a control unit that acquires information related to a vehicle traveling in one area and compares the acquired information with past data in which the information and land price information are associated with each other for each area so as to estimate the land price information in the one area.

A program according to an embodiment of the present disclosure causes an information processing device to perform operations including: acquiring information related to a vehicle traveling in one area; comparing the acquired information with past data in which the information and land price information are associated with each other for each area; and estimating the land price information in the one area.

A vehicle according to an embodiment of the present disclosure includes a control unit that acquires information related to the vehicle traveling in one area and compares the acquired information with past data in which the information and land price information are associated with each other for each area so as to estimate the land price information in the one area.

With the information processing device, the information processing system, the program, and the vehicle according to the embodiment of the present disclosure, it is possible to accurately estimate the land price information in accordance with the vehicle traveling in one area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a configuration of an information processing system including an information processing device according to an embodiment of the present disclosure;

FIG. 2 is a functional block diagram showing a schematic configuration of each of the information processing device and a vehicle shown in FIG. 1;

FIG. 3 is a first diagram illustrating a first example of process executed by a control unit of the information processing device shown in FIG. 2;

FIG. 4 is a second diagram illustrating the first example of the process executed by the control unit of the information processing device shown in FIG. 2;

FIG. 5 is a diagram illustrating a second example of the process executed by the control unit of the information processing device shown in FIG. 2;

FIG. 6 is a flowchart illustrating a first example of an information processing method executed by the information processing device shown in FIG. 1;

FIG. 7 is a flowchart illustrating a second example of the information processing method executed by the information processing device shown in FIG. 1;

FIG. 8 is a flowchart illustrating a third example of the information processing method executed by the information processing device shown in FIG. 1; and

FIG. 9 is a flowchart illustrating a fourth example of the information processing method executed by the information processing device shown in FIG. 1.

### DETAILED DESCRIPTION OF EMBODIMENTS

Hereinafter, embodiments of the present disclosure will be described below with reference to the drawings.

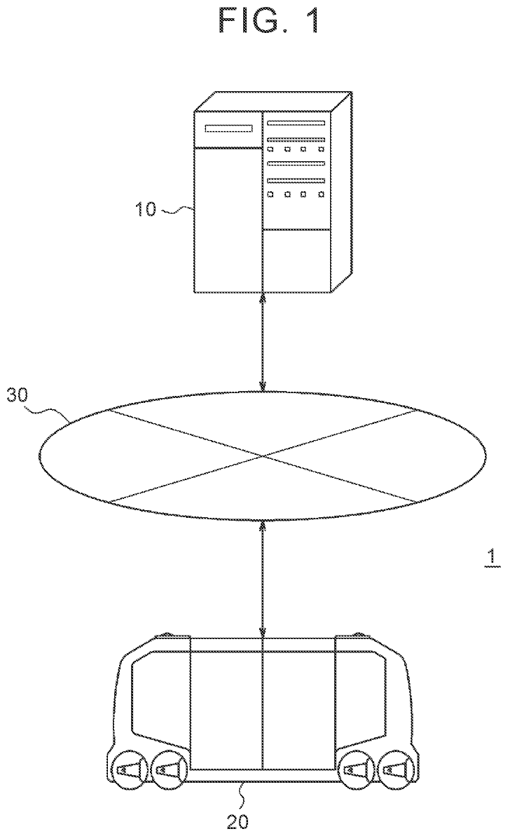

FIG. 1 is a configuration diagram showing a configuration of an information processing system 1 including an information processing device 10 according to an embodiment of the present disclosure. An outline of the information processing system 1 including the information processing device 10 according to the embodiment of the present disclosure will be mainly described with reference to FIG. 1. The information processing system 1 includes a vehicle 20 in addition to the information processing device 10.

For convenience of description, FIG. 1 shows a single information processing device 10 and a single vehicle 20. However, the numbers of the information processing devices 10 and the vehicles 20 included in the information processing system 1 may be two or more. For example, an occupant may continuously use the same vehicle 20, or may use any one of a plurality of the vehicles 20 while changing the vehicle 20 every time the occupant is on board or by a predetermined period. Each of the information processing device 10 and the vehicle 20 is connected to a network 30 including a mobile communication network and the Internet, for example, so as to be able to communicate with each other.

The information processing device 10 is a server or a plurality of servers that can communicate with each other. The information processing device 10 is not limited to the above, and may be any general-purpose electronic device such as a personal computer (PC) or a smartphone, or may be another electronic device dedicated to the information processing system 1.

The vehicle 20 is, for example, an automobile. The vehicle 20 is not limited to this, and may be any vehicle that allows a human to board and drive to a destination. The vehicle 20 is, for example, a vehicle that performs autonomous driving. Autonomous driving includes, for example, Levels 1 to 5 defined by the Society of Automotive Engineers (SAE). However, autonomous driving is not limited to the above, and may be appropriately defined. The vehicle 20 is not limited to the vehicle that performs autonomous driving, and may be any vehicle driven by a driver.

As an outline of one embodiment, the information processing device 10 acquires information related to the vehicle 20 traveling in one area. In the present specification, the “one area” includes, for example, any range such as a range of cities, wards, towns and villages that are the smallest administrative divisions, a range that is further subdivided than the range cities, wards, towns and villages and that is designated with a street address, and a range of prefectures that is larger than the range of cities, wards, towns and villages.

In the present specification, the “information related to the vehicle 20” includes, for example, at least one of traveling information of the vehicle 20 obtained in relation to driving of the vehicle 20, occupant information of occupants of the vehicle 20, and vehicle type information of the vehicle 20. The “traveling information” includes, for example, speed, acceleration, angular velocity, braking operation, steering operation, dangerous driving information, traffic congestion information, number of accidents, boarding time, traveling lane, autonomous driving state, and the like of the vehicle 20. The “occupant information” includes, for example, the number of occupants, age, gender, weight, physique, clothing, race, conversation content, behavior, and the like. The “vehicle type information” may include, for example, rough categories relating to a vehicle type, such as luxury vehicles and popular vehicles, and regular vehicles and light vehicles, or may include a specific vehicle type. The occupants of the vehicle 20 may be one person or a plurality of people.

The information processing device 10 compares the acquired information related to the vehicle 20 with the past data in which the information related to the vehicle 20 and the land price information are associated with each other for each area. Thereby, the information processing device 10 estimates the land price information in one area. In the present specification, the “land price information” includes actual land prices, official land prices, standard land prices, roadside land prices, and the like. The land price information may be represented by, for example, specific numerical values, or may be represented by predetermined levels. The “past data” includes, for example, big data in which the information related to the vehicle 20 obtained in the past for the vehicles 20 traveling in a plurality of areas and the land price information are associated with each other for each area.

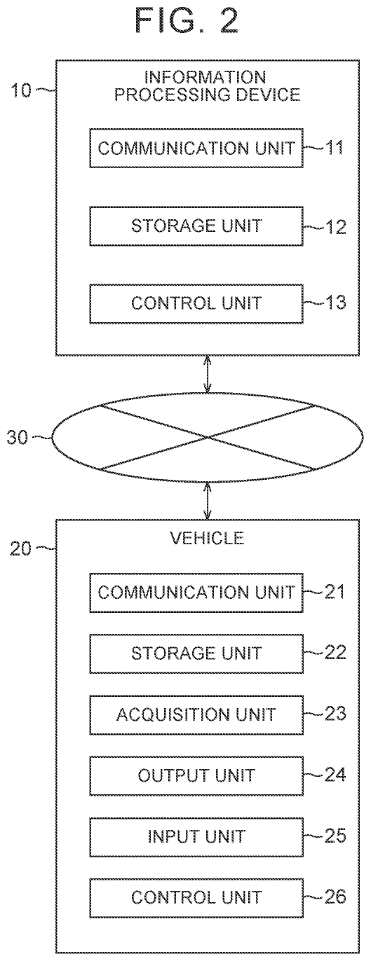

Next, with reference to FIG. 2, configurations of the information processing device 10 and the vehicle 20 included in the information processing system 1 will be mainly described. FIG. 2 is a functional block diagram showing a schematic configuration of each of the information processing device 10 and the vehicle 20 shown in FIG. 1.

As shown in FIG. 2, the vehicle 20 includes a communication unit 21, a storage unit 22, an acquisition unit 23, an output unit 24, an input unit 25, and a control unit 26. The communication unit 21, the storage unit 22, the acquisition unit 23, the output unit 24, the input unit 25, and the control unit 26 are connected to each other so as to be able to communicate with each other via an in-vehicle network such as a controller area network (CAN) or a dedicated line.

The communication unit 21 includes a communication module connected to the network 30. For example, the communication unit 21 may include a communication module corresponding to a mobile communication standard such as the fourth generation (4G) and the fifth generation (5G). According to the embodiment, the vehicle 20 is connected to the network 30 via the communication unit 21. The communication unit 21 transmits and receives various types of information via the network 30.

The storage unit 22 is, for example, a semiconductor memory, a magnetic memory, or an optical memory. However, the storage unit 22 is not limited to these memories. The storage unit 22 may function as, for example, a main storage device, an auxiliary storage device, or a cache memory. The storage unit 22 stores any information used for operating the vehicle 20. For example, the storage unit 22 stores information related to the vehicle 20 traveling in one area, which is acquired by the acquisition unit 23. In addition, for example, the storage unit 22 may store a system program, an application program, and various types of information received by the communication unit 21. The information stored in the storage unit 22 may be updatable with information received from the network 30 via the communication unit 21, for example.

The acquisition unit 23 includes any module capable of acquiring information related to the vehicle 20 traveling in one area. For example, the acquisition unit 23 includes any sensor module capable of acquiring various traveling information. For example, the acquisition unit 23 includes any module capable of acquiring various occupant information. For example, the acquisition unit 23 includes a seating sensor installed in a seat of the vehicle 20 such as a driver's seat, a passenger seat, and a rear seat in which an occupant is seated. For example, the acquisition unit 23 includes a camera module, a microphone, and any other sensor module installed in the vehicle cabin of the vehicle 20 and connected to the CAN. For example, the acquisition unit 23 may acquire the vehicle type information in advance when the vehicle 20 is manufactured and delivered.

In addition, the acquisition unit 23 may include one or more receivers corresponding to any satellite positioning system. For example, the acquisition unit 23 may include a global positioning system (GPS) receiver. The acquisition unit 23 acquires a measured value of the position of the vehicle 20 as the position information. The position information includes, for example, an address, latitude, longitude, and altitude. The acquisition unit 23 may acquire the position information of the vehicle 20 constantly or may acquire the position information periodically or non-periodically.

For example, the output unit 24 outputs, as needed, various information received by the vehicle 20 from the information processing device 10 to the occupants in the vehicle cabin of the vehicle 20. For example, the output unit 24 includes a car navigation device. For example, the output unit 24 includes an output device such as a liquid crystal monitor that constitutes the car navigation device. The car navigation device constituting the output unit 24 outputs, for example, various information using at least either of an image and a sound.

The output unit 24 is not limited to this, and may include any output device that affects at least either of visual and auditory senses of the occupant of the vehicle 20. The output unit 24 may include, for example, any audio output device other than the car navigation device, which mainly affects the hearing of the occupant of the vehicle 20. The output unit 24 may include, for example, any image output device other than the car navigation device, which mainly affects the visual sense of the occupant of the vehicle 20.

The input unit 25 includes, for example, one or more input interfaces that receive an input operation by the occupant in response to the information output by the output unit 24 and acquire input information based on the input operation by the occupant.

For example, the input unit 25 includes a car navigation device that constitutes the output unit 24. For example, the input unit 25 includes a touch screen provided integrally with the liquid crystal monitor constituting the car navigation device. The car navigation device constituting the input unit 25 receives, for example, the input operation by the occupant based on a touch operation by the occupant.

The input unit 25 is not limited to this, and may include any input interface capable of detecting the input operation by the occupant and acquiring the input information based on the input operation by the occupant. The input unit 25 may include, for example, a physical key, a capacitance key, and a microphone that accepts voice inputs.

The control unit 26 includes one or more processors. According to the embodiment, the “processor” is a general-purpose processor or a dedicated processor specialized for specific processing. However, the processor is not limited thereto. For example, the control unit 26 may include an electronic control unit (ECU). The control unit 26 is connected to each component constituting the vehicle 20 so as to be able to communicate with each other and controls the operation of the entire vehicle 20.

The control unit 26 acquires the information related to the vehicle 20 using the acquisition unit 23. For example, the control unit 26 acquires the traveling information of the vehicle 20 using the acquisition unit 23. For example, the control unit 26 acquires the occupant information of the occupants of the vehicle 20 for each of the occupants of the vehicle 20. For example, the control unit 26 acquires in advance the vehicle type information of the vehicle 20 using the acquisition unit 23. The control unit 26 transmits the information related to the vehicle 20 acquired by the acquisition unit 23 to the information processing device 10 via the communication unit 21 and the network 30.

For example, the control unit 26 receives the land price information in one area that is estimated by the information processing device 10, from the information processing device 10 via the network 30 and the communication unit 21. For example, the control unit 26 receives information on a braking point, described later, in one area that is specified by the information processing device 10, from the information processing device 10 via the network 30 and the communication unit 21. For example, the control unit 26 receives shop opening information, described later, in one area that is estimated by the information processing device 10, from the information processing device 10 via the network 30 and the communication unit 21.

For example, the control unit 26 receives information on a point with a high probability of an accident, described later, in one area that is estimated by the information processing device 10, from the information processing device 10 via the network 30 and the communication unit 21. For example, the control unit 26 receives optimum route information, described later, in one area that is determined by the information processing device 10, from the information processing device 10 via the network 30 and the communication unit 21. For example, the control unit 26 receives information on resident attributes, described later, in one area that is estimated by the information processing device 10, from the information processing device 10 via the network 30 and the communication unit 21.

The control unit 26 may receive, for example, information regarding autonomous driving determined by any other external device connected to the information processing device 10 or the network 30 via the network 30 and the communication unit 21. The control unit 26 executes vehicle control for the vehicle 20 based on, for example, the optimum route information, described later, received from the information processing device 10 and the received information regarding autonomous driving. In the present specification, the “vehicle control” includes, but is not limited to, autonomous driving to a destination, for example.

Next, the configuration of the information processing device 10 included in the information processing system 1 will be mainly described. As shown in FIG. 2, the information processing device 10 includes a communication unit 11, a storage unit 12, and a control unit 13.

The communication unit 11 includes a communication module connected to the network 30. For example, the communication unit 11 may include a communication module compatible with mobile communication standards such as 4G and 5G or the Internet standards. According to the embodiment, the information processing device 10 is connected to the network 30 via the communication unit 11. The communication unit 11 transmits and receives various types of information via the network 30.

The storage unit 12 is, for example, a semiconductor memory, a magnetic memory, or an optical memory. However, the storage unit 12 is not limited to these memories. The storage unit 12 may function as, for example, a main storage device, an auxiliary storage device, or a cache memory. The storage unit 12 stores any information used for the operation of the information processing device 10. For example, the storage unit 12 may store a system program, an application program, and various types of information received by the communication unit 11. The information stored in the storage unit 12 may be updatable with information received from the network 30 via the communication unit 11, for example.

The control unit 13 includes one or more processors. According to the embodiment, the “processor” is a general-purpose processor or a dedicated processor specialized for specific processing. However, the processor is not limited thereto. The control unit 13 is connected to each of the constituent units of the information processing device 10 so as to be able to communicate with each other and controls the overall operation of the information processing device 10.

The control unit 13 acquires information related to the vehicle 20 traveling in one area. For example, the control unit 13 receives the information related to the vehicle 20 from the vehicle 20 via the network 30 and the communication unit 11.

The control unit 13 compares the acquired information related to the vehicle 20 with the past data in which the information related to the vehicle 20 and the land price information are associated with each other for each area. The control unit 13 may receive the past data from any other external device via the network 30 and the communication unit 11 and store the past data in the storage unit 12. Thus, the control unit 13 estimates the land price information in one area.

The control unit 13 may provide the estimated land price information in one area to any target via the network 30. For example, the control unit 13 may transmit the estimated land price information in one area to the vehicle 20 via the communication unit 11 and the network 30. The present disclosure is not limited to this, and the control unit 13 may set the estimated land price information in one area such that it can be accessed from a terminal device of any user or business operator connected to the network 30, for example.

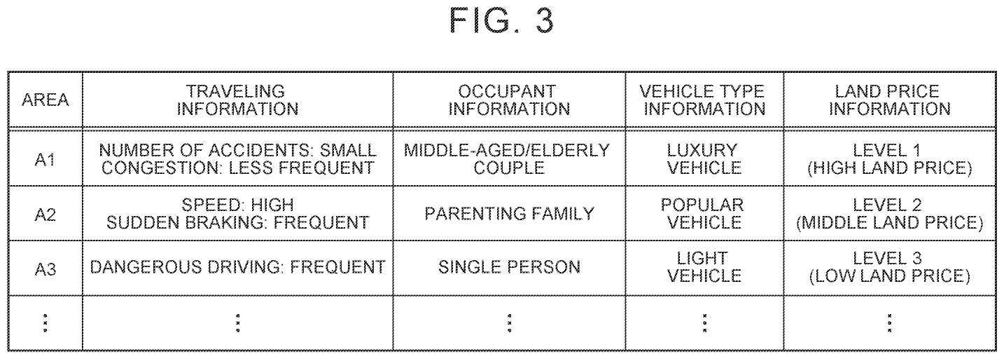

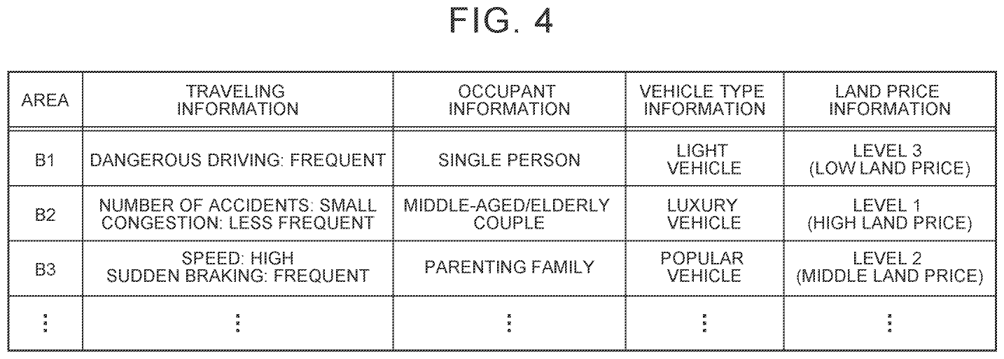

FIG. 3 is a first diagram illustrating a first example of a process executed by the control unit 13 of the information processing device 10 shown in FIG. 2. FIG. 4 is a second diagram illustrating the first example of the process executed by the control unit 13 of the information processing device 10 shown in FIG. 2. FIG. 4 shows an example of the past data. The first example of the process to be executed by the control unit 13 will be described more specifically with reference to FIGS. 3 and 4.

In the first example of the process executed by the control unit 13, the land price information in one area is estimated based on the information related to the vehicle 20 acquired by the control unit 13. Although three areas A1, A2, and A3 are shown in FIG. 3, the number of areas corresponding to the land price information estimated by the control unit 13 does not have to be three. Similarly, although FIG. 4 shows three areas B1, B2, and B3, the number of areas included in the past data does not have to be three.

The control unit 13 acquires information indicating fewer accidents and less congestion as the traveling information of the vehicle 20 traveling in one area A1. The control unit 13 acquires information indicating a middle-aged or elderly couple as the occupant information of the occupants of the vehicle 20 traveling in one area A1. The control unit 13 acquires information indicating a luxury vehicle as the vehicle type information of the vehicle 20 traveling in one area A1. The control unit 13 compares the acquired information related to the vehicle 20 with the past data.

More specifically, the control unit 13 compares the information related to the vehicle 20 traveling in one area A1 with the past data for the area B2. In the past data for the area B2, the traveling information includes information indicating fewer accidents and less congestion. The occupant information includes information indicating a middle-aged or elderly couple. The vehicle type information includes information indicating a luxury vehicle. In this way, the control unit 13 executes the comparison process with reference to the past data for the area B2 including the information similar to the information related to the vehicle 20 traveling in one area A1.

In such a comparison process, the control unit 13 refers to, as the land price information for the area B2, the information indicating level 1 (high land price) that is associated with the information similar to the information related to the vehicle 20 traveling in one area A1. Thereby, the control unit 13 estimates the information indicating level 1 (high land price) as the land price information in one area A1.

The control unit 13 acquires information indicating higher speed and more sudden brakes as the traveling information of the vehicle 20 traveling in one area A2. The control unit 13 acquires information indicating a parenting family as the occupant information of the occupants of the vehicle 20 traveling in one area A2. The control unit 13 acquires information indicating a popular vehicle as the vehicle type information of the vehicle 20 traveling in one area A2. The control unit 13 compares the acquired information related to the vehicle 20 with the past data.

More specifically, the control unit 13 compares the information related to the vehicle 20 traveling in one area A2 with the past data for the area B3. In the past data for the area B3, the traveling information includes information indicating higher speed and more sudden brakes. The occupant information includes information indicating a parenting family. The vehicle type information includes information indicating a popular vehicle. In this way, the control unit 13 executes the comparison process with reference to the past data for the area B3 including the information similar to the information related to the vehicle 20 traveling in one area A2.

In such a comparison process, the control unit 13 refers to, as the land price information for the area B3, the information indicating level 2 (medium land price) that is associated with the information similar to the information related to the vehicle 20 traveling in one area A2. Thereby, the control unit 13 estimates the information indicating level 2 (medium land price) as the land price information in one area A2.

The control unit 13 acquires information indicating more frequent dangerous driving as the traveling information of the vehicle 20 traveling in one area A3. The control unit 13 acquires information indicating a single person as the occupant information of the occupant of the vehicle 20 traveling in one area A3. The control unit 13 acquires information indicating a light vehicle as the vehicle type information of the vehicle 20 traveling in one area A3. The control unit 13 compares the acquired information related to the vehicle 20 with the past data.

More specifically, the control unit 13 compares the information related to the vehicle 20 traveling in one area A3 with the past data for the area B1. In the past data for the area B1, the traveling information includes information indicating more frequent dangerous driving. The occupant information includes information indicating a single person. The vehicle type information includes information indicating a light vehicle. In this way, the control unit 13 executes the comparison process with reference to the past data for the area B1 including the information similar to the information related to the vehicle 20 traveling in one area A3.

In such a comparison process, the control unit 13 refers to, as the land price information for the area B1, the information indicating level 3 (low land price) that is associated with the information similar to the information related to the vehicle 20 traveling in one area A3. Thereby, the control unit 13 estimates the information indicating level 3 (low land price) as the land price information in one area A3.

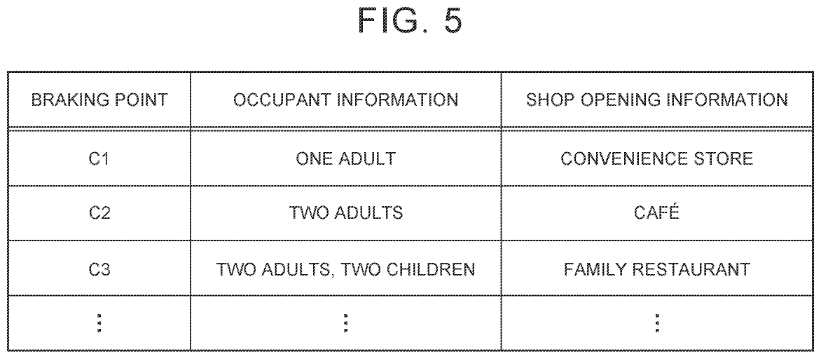

FIG. 5 is a diagram illustrating a second example of the process executed by the control unit 13 of the information processing device 10 shown in FIG. 2. The second example of the process executed by the control unit 13 will be described more specifically with reference to FIG. 5.

In the second example of the process executed by the control unit 13, the control unit 13 acquires the traveling information of the vehicle 20 traveling in one area and position information of the vehicle 20 associated with the traveling information. Based on the acquired traveling information and position information, the control unit 13 specifies the braking point where the brake is applied while the vehicle 20 is traveling in one area.

The control unit 13 may provide the information on the specified braking point in one area to any target via the network 30. For example, the control unit 13 may transmit the information on the specified braking point in one area to the vehicle 20 via the communication unit 11 and the network 30. The present disclosure is not limited to this, and the control unit 13 may set the information on the specified braking point in one area such that it can be accessed from a terminal device of any user or business operator connected to the network 30, for example.

The control unit 13 further acquires the occupant information of the occupants of the vehicle 20 associated with the traveling information and the position information, and generates the shop opening information of a shop to be opened adjacent to the specified braking point based on the acquired occupant information. In the present specification, the “shop opening information” includes design information of the shop, such as the type of the shop offering services related to retail, food and beverage, health, healing, accommodation, entertainment, etc., the size of the shop, the location of the parking lot, the entrance/exit of the parking lot, and the entrance/exit of the shop.

The control unit 13 may provide the generated shop opening information in one area to any target via the network 30. For example, the control unit 13 may transmit the generated shop opening information in one area to the vehicle 20 via the communication unit 11 and the network 30. The present disclosure is not limited to this, and the control unit 13 may set the generated shop opening information in one area such that it can be accessed from a terminal device of any user or business operator connected to the network 30, for example.

Although three braking points C1, C2, and C3 are shown in FIG. 5, the number of braking points in one area specified by the control unit 13 does not have to be three.

The control unit 13 acquires the traveling information of the vehicle 20 traveling in one area and the position information of the vehicle 20 associated with the traveling information, and specifies the braking point C1 where the brake is applied while the vehicle 20 is traveling in one area. The control unit 13 further acquires the information indicating one adult as the occupant information of the occupants of the vehicle 20 associated with the traveling information and the position information. The control unit 13 generates information indicating a convenience store as the shop opening information of the shop to be opened adjacent to the specified braking point C1 based on the acquired occupant information indicating one adult.

Similarly, the control unit 13 specifies the braking point C2 in one area. The control unit 13 further acquires the information indicating two adults as the occupant information of the occupants of the vehicle 20 associated with the traveling information and the position information. The control unit 13 generates information indicating a café as the shop opening information of the shop to be opened adjacent to the specified braking point C2 based on the acquired occupant information indicating two adults.

Similarly, the control unit 13 specifies the braking point C3 in one area. The control unit 13 further acquires the information indicating two adults and two children as the occupant information of the occupants of the vehicle 20 associated with the traveling information and the position information. The control unit 13 generates information indicating a family restaurant as the shop opening information of the shop to be opened adjacent to the specified braking point C3 based on the acquired occupant information indicating two adults and two children.

In addition to the first and second examples of the process executed by the control unit 13 as described above, the control unit 13 may execute the following process.

The control unit 13 acquires the traveling information of the vehicle 20 traveling in one area and the position information of the vehicle 20 associated with the traveling information. The control unit 13 may estimate a point with a high probability of an accident in one area based on the acquired traveling information and position information. For example, the control unit 13 may specify a point where sudden braking or dangerous driving is frequent based on the acquired traveling information and position information and estimate the specified point as the point with a high probability of an accident in one area. Similarly, the control unit 13 may estimate a point where the speed of the vehicle 20 is relatively high as the point with a high probability of an accident in one area. Similarly, the control unit 13 may estimate a point where the steering operation tends to be relatively rough as the point with a high probability of an accident in one area.

The control unit 13 may provide information on the estimated point with a high probability of an accident in one area to any target via the network 30. For example, the control unit 13 may transmit the information on the estimated point with a high probability of an accident in one area to the vehicle 20 via the communication unit 11 and the network 30. The present disclosure is not limited to this, and the control unit 13 may set the information on the estimated point with a high probability of an accident in one area such that it can be accessed from a terminal device of any user or business operator connected to the network 30, for example.

The control unit 13 acquires the traveling information of the vehicle 20 traveling in one area and the position information of the vehicle 20 associated with the traveling information. The control unit 13 may determine the optimum route information related to the life of the residents in one area or business activities of the business operators in one area based on the acquired traveling information and position information. In the present specification, the “route information related to the life of the residents in one area” includes, for example, jogging routes, walking routes, shopping routes, hospital routes, school routes, commuting routes, and the like. The “route information related to business activities of the business operators in one area” includes, for example, preview routes of real estate agents, transportation routes for transporting goods to retail stores such as convenience stores and supermarkets, and transportation routes for construction companies to transport materials to construction sites.

For example, the control unit 13 may specify a point where traffic congestion is frequent based on the acquired traveling information and position information and determine a route that avoids the specified point as the optimum route information. For example, as described above, the control unit 13 may specify a braking point in one area and determine a route that avoids the specified braking point as the optimum route information. For example, as described above, the control unit 13 may estimate a point with a high probability of an accident in one area, and determine a route that avoids the estimated point as the optimum route information.

The control unit 13 may provide the determined optimum route information in one area to any target via the network 30. For example, the control unit 13 may transmit the determined optimum route information in one area to the vehicle 20 via the communication unit 11 and the network 30. The present disclosure is not limited to this, and the control unit 13 may set the determined optimum route information in one area so that it can be accessed from a terminal device of any user or business operator connected to the network 30, for example.

The control unit 13 acquires the occupant information of the occupants of the vehicle 20 traveling in one area. The control unit 13 may estimate the resident attributes in one area based on the acquired occupant information. In the present specification, the “resident attributes” include a standard of living, an income level, household compositions, places of origin, nationalities, etc. of the residents.

The control unit 13 may provide the information on the estimated resident attributes in one area to any target via the network 30. For example, the control unit 13 may transmit the information on the estimated resident attributes in one area to the vehicle 20 via the communication unit 11 and the network 30. The present disclosure is not limited to this, and the control unit 13 may set the information on the estimated resident attributes in one area such that it can be accessed from a terminal device of any user or business operator connected to the network 30, for example.

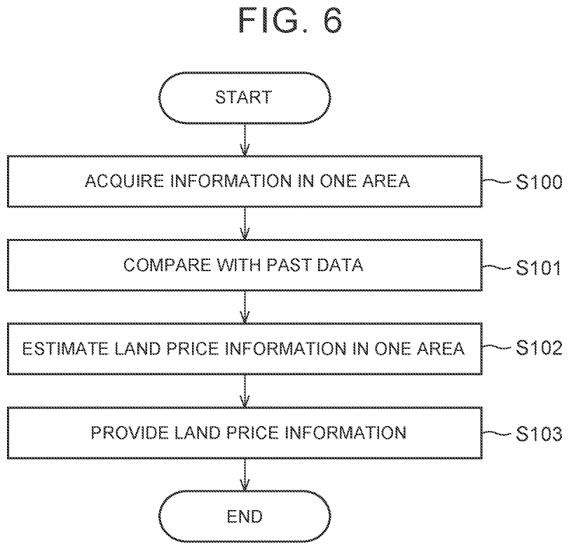

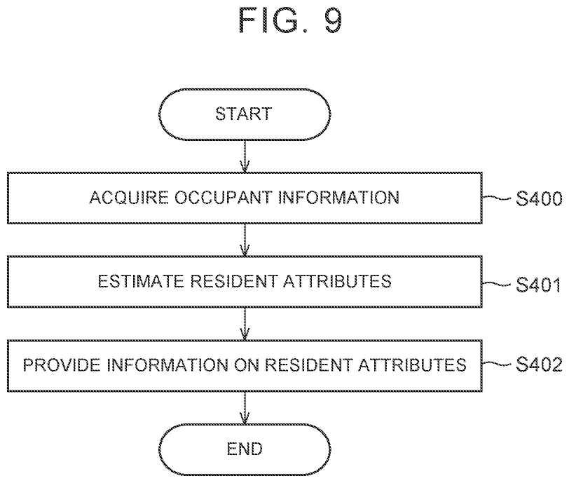

Next, an information processing method executed by the control unit 13 of the information processing device 10 according to the embodiment will be described with reference to FIGS. 6 and 9. FIG. 6 is a flowchart illustrating a first example of the information processing method executed by the information processing device 10 shown in FIG. 1. In the first example of the information processing method, the basic flow regarding the first example of the process executed by the control unit 13 of the information processing device 10 will be described.

In step S100, the control unit 13 acquires information related to the vehicle 20 traveling in one area. For example, the control unit 13 receives the information related to the vehicle 20 acquired by the acquisition unit 23 of the vehicle 20 from the vehicle 20 via the network 30 and the communication unit 11.

In step S101, the control unit 13 compares the information related to the vehicle 20 acquired in step S100 with the past data in which the information related to the vehicle 20 and the land price information are associated with each other for each area.

In step S102, the control unit 13 estimates the land price information in one area based on the comparison process in step S101.

In step S103, the control unit 13 provides the land price information in one area estimated in step S102 to any target via the network 30.

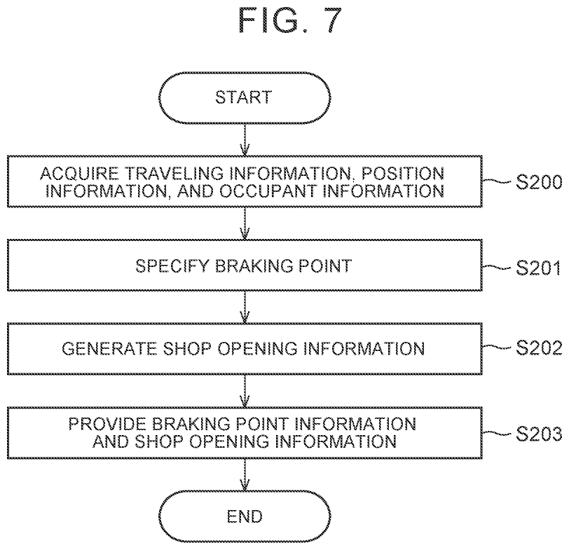

FIG. 7 is a flowchart illustrating a second example of the information processing method executed by the information processing device 10 shown in FIG. 1. In the second example of the information processing method, the basic flow regarding the second example of the process executed by the control unit 13 of the information processing device 10 will be described.

In step S200, the control unit 13 acquires the traveling information of the vehicle 20 traveling in one area, the position information of the vehicle 20 associated with the traveling information, and the occupant information of the occupants of the vehicle 20 associated with the traveling information and the position information. For example, the control unit 13 receives the information acquired by the acquisition unit 23 of the vehicle 20 from the vehicle 20 via the network 30 and the communication unit 11.

In step S201, the control unit 13 specifies the braking point where the brake is applied while the vehicle 20 is traveling in one area based on the traveling information and position information acquired in step S200.

In step S202, the control unit 13 generates the shop opening information of the shop to be opened adjacent to the braking point specified in step S201 based on the occupant information acquired in step S200.

In step S203, the control unit 13 provides the information on the braking point specified in step S201 and the shop opening information generated in step S202 to any target via the network 30.

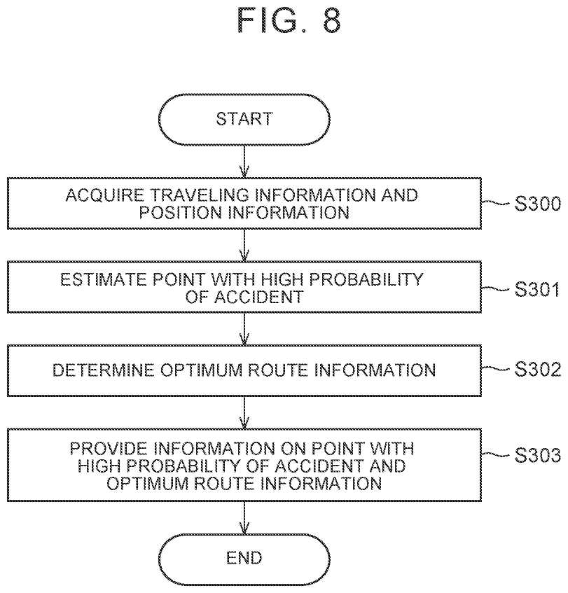

FIG. 8 is a flowchart illustrating a third example of the information processing method executed by the information processing device 10 shown in FIG. 1. FIG. 9 is a flowchart illustrating a fourth example of the information processing method executed by the information processing device 10 shown in FIG. 1. In the third and fourth examples of the information processing method, basic flows regarding other processes that are different from the first and second examples of the above-described process and that are executed by the control unit 13 of the information processing device 10 will be described.

In step S300, the control unit 13 acquires the traveling information of the vehicle 20 traveling in one area and the position information of the vehicle 20 associated with the traveling information. For example, the control unit 13 receives the information acquired by the acquisition unit 23 of the vehicle 20 from the vehicle 20 via the network 30 and the communication unit 11.

In step S301, the control unit 13 estimates the point with a high probability of an accident in one area based on the traveling information and the position information acquired in step S300.

In step S302, the control unit 13 determines the optimum route information related to the life of the residents in one area or the business activities of the business operators in one area based on the traveling information and the position information acquired in step S300. For example, the control unit 13 may determine as the optimum route information a route that avoids the point with a high probability of an accident in one area estimated in step S301.

In step S303, the control unit 13 provides the information on the point with a high probability of an accident in one area estimated in step S301 and the optimum route information in one area determined in step S302 to any target via the network 30.

In step S400, the control unit 13 acquires the occupant information of the occupants of the vehicle 20 traveling in one area. For example, the control unit 13 receives the occupant information acquired by the acquisition unit 23 of the vehicle 20 from the vehicle 20 via the network 30 and the communication unit 11.

In step S401, the control unit 13 estimates the resident attributes in one area based on the occupant information acquired in step S400.

In step S402, the control unit 13 provides the information on the resident attributes in one area estimated in step S401 to any target via the network 30.

In the above embodiment, it is possible to accurately estimate the land price information in accordance with the vehicle 20 traveling in one area. For example, the information processing device 10 can accurately estimate the land price information in accordance with the traveling vehicle 20 by estimating the land price information in one area based on the acquired information related to the vehicle 20.

For example, the information processing device 10 estimates the land price information in one area based on the traveling information of the vehicle 20, so as to be able to accurately estimate the land price information in consideration of indices such as ease of traveling of the vehicle 20 and the probability of an accident. For example, the information processing device 10 estimates the land price information in one area based on the occupant information of the occupants of the vehicle 20, so as to be able to accurately estimate the land price information in consideration of indices such as the attributes of the residents riding in the vehicle 20. For example, the information processing device 10 estimates the land price information in one area based on the vehicle type information of the vehicle 20, so as to be able to accurately estimate the land price information using the type of the vehicle 20 as an index.

As described above, the information processing device 10 can accurately estimate the actual land price information in one area in accordance with the vehicle 20, which reflects actual conditions of the residents, living conditions of the residents, and the like in one area. The business operator receiving such land price information such as a real estate agent can set a real estate price that appropriately reflects the actual conditions of residents, the living conditions of residents, and the like in one area. The user who receives such land price information can appropriately select an area that suits himself/herself, e.g., an area to move, while fully considering the actual conditions of the residents, the living conditions of the residents, and the like in one area.

Based on the acquired traveling information and position information, the information processing device 10 specifies the braking point where the brake is applied while the vehicle 20 is traveling. Thereby, the information processing device 10 can also generate map information indicating the braking points superimposed on the map as the braking point information. The information processing device 10 can also provide such map information to any target via the network 30. The Business operator that receives such map information can build their own business strategies, including the route information and the shop opening plans related to the business activities of the business operator in one area, while utilizing the information on the braking points. The user who receives such map information can also intentionally avoid the braking points in one area when he/she determines the route information related to the life of the residents in one area by himself/herself in daily life.

The information processing device 10 generates the shop opening information of the shop to be opened adjacent to the specified braking point based on the acquired occupant information, which can contribute to the construction of a business strategy of the business operator. For example, the business operator that receives such shop opening information can accurately determine opening points of the shops that the business operator should open to offer a service, based on the information on the braking points. That is, the information processing device 10 can also provide a determination standard for construction of the business strategies such as the shop opening plan of the business operator.

Referring to FIG. 5, for example, a business operator of convenience stores considering opening a new store can determine that the new store should be opened adjacent to the braking point C1 based on the information on the braking points specified by the information processing device 10 and the shop opening information generated by the information processing device 10. Similarly, a business operator of café can determine that a café should be opened adjacent to the braking point C2. Similarly, a business operator of family restaurants can determine that a restaurant should be opened adjacent to the braking point C3. As described above, the business operators can easily perform analysis of trade areas accompanying opening of a new store.

The information processing device 10 estimates the point with a high probability of an accident in one area based on the acquired traveling information and position information, so as to be able to generate the map information indicating such points superimposed on the map as the information on the point with a high probability of an accident. The information processing device 10 can also provide such map information to any target via the network 30. The business operator that receives such map information can build their own business strategies, including the route information and the shop opening plans related to the business activities of the business operator in one area, while utilizing the information on the point with a high probability of an accident. The user who receives such map information can also intentionally avoid the point with a high probability of an accident in one area when he/she determines the route information related to the life of the residents in one area by himself/herself in daily life.

The information processing device 10 determines the optimum route information related to the life of the residents in one area or the business activities of the business operator in one area based on the acquired traveling information and position information, which improves the convenience for the user and the business operator.

For example, the business operator need not to determine the route information related to the business activities thereof in one area by themselves, and only needs to receive the optimum route information from the information processing device 10. For example, the user need not to determine the route information related to the life of the residents in one area by himself/herself, and only needs to receive the optimum route information from the information processing device 10.

The information processing device 10 can accurately estimate the land price information in accordance with the vehicle 20 traveling in one area by estimating the resident attributes in one area based on the acquired occupant information. For example, the information processing device 10 can accurately estimate the land price information in one area based on the occupant information of the occupants of the vehicle 20 in consideration of the attributes of the residents riding in the vehicle 20 as an index.

The information processing device 10 can accurately estimate the land price information in one area by comparing the acquired information related to the vehicle 20 with the past data including big data.

Although the present disclosure has been described above based on the drawings and the embodiments, it should be noted that those skilled in the art can easily make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, at least a part of the processing operations executed by the information processing device 10 in the above embodiment may be executed by the vehicle 20. For example, instead of the information processing device 10, the vehicle 20 itself may execute the processing operations above related to the information processing device 10. At least a part of the processing operations executed by the vehicle 20 may be executed by the information processing device 10.

For example, a general-purpose electronic device such as a smartphone or a computer may function as the information processing device 10 according to the above embodiment. Specifically, a program including processing content for realizing each function of the information processing device 10 according to the embodiment is stored in a memory of the electronic device, and the program is read and executed by the processor of the electronic device. Thus, the disclosure according to the embodiment can also be realized as a program that can be executed by the processor. Alternatively, the disclosure according to the embodiment can also be realized as a non-transitory computer-readable medium that stores a program executable by one or more processors to cause the information processing device 10 etc. according to the embodiment to execute each function. It should be understood that the above configurations are also included in the scope of the present disclosure.

For example, the information processing device 10 described in the above embodiment may be mounted on the vehicle 20. With the configuration above, the information processing device 10 may directly perform information communication with the vehicle 20 without the network 30.

In the above embodiment, the information processing device 10 has been described as providing various information to the vehicle 20, but the present disclosure is not limited to this. The information processing device 10 may provide various information to the terminal device of the occupant of the vehicle 20 in place of or in addition to the vehicle 20. With the configuration above, the information processing system 1 may include the terminal device of the occupant of the vehicle 20 in place of or in addition to the information processing device 10 and the vehicle 20.

In the above embodiment, it has been described that the past data includes, for example, big data, but the present disclosure is not limited to this. The past data may include any data in which the information related to the vehicle 20 and the land price information are associated with each other for each area.

In the above embodiment, the information processing device 10 has been described as acquiring the past data from any other external device via the network 30 and the communication unit 11, but the present disclosure is not limited to this. The information processing device 10 itself may acquire the information related to the vehicle 20 traveling in a plurality of areas and the land price information corresponding to each of the areas to generate the past data. The information processing device 10 may store the past data generated in this way in the storage unit 12.

In the above embodiment, the information related to the vehicle 20 has been described as including at least one of the traveling information of the vehicle 20, the occupant information of the occupants of the vehicle 20, and the vehicle type information of the vehicle 20, but the present disclosure is not limited to this. The information related to the vehicle 20 may include, in addition to or in place of such information, road information, traffic information, buildings information, and the like acquired by a camera module that is installed outside the vehicle cabin of the vehicle 20 and connected to the CAN, for example.

What is claimed is:

1. An information processing device comprising a control unit that acquires information related to a vehicle traveling in one area and compares the acquired information with past data in which the information and land price information are associated with each other for each area so as to estimate the land price information in the one area.

2. The information processing device according to claim 1, wherein the information includes at least one of traveling information of the vehicle obtained in connection with driving of the vehicle, occupant information of an occupant of the vehicle, and vehicle type information of the vehicle.

3. The information processing device according to claim 2, wherein the control unit acquires the traveling information and position information of the vehicle that is associated with the traveling information, and specifies a braking point where a brake is applied while the vehicle is traveling based on the acquired traveling information and position information.

4. The information processing device according to claim 3, wherein the control unit further acquires the occupant information associated with the traveling information and the position information, and generates shop opening information of a shop to be opened adjacent to the specified braking point based on the acquired occupant information.

5. The information processing device according to claim 2, wherein the control unit acquires the traveling information and position information of the vehicle that is associated with the traveling information, and estimates a point with a high probability of an accident in the one area based on the acquired traveling information and position information.

6. The information processing device according to claim 2, wherein the control unit acquires the traveling information and position information of the vehicle that is associated with the traveling information, and determines optimum route information related to life of a resident in the one area or a business activity of a business operator in the one area based on the acquired traveling information and position information.

7. The information processing device according to claim 2, wherein the control unit acquires the occupant information and estimates a resident attribute in the one area based on the acquired occupant information.

8. An information processing system comprising:
the information processing device according to claim 1; and
the vehicle that provides the information related to the vehicle to the information processing device.

9. A program that causes an information processing device to perform operations including:
acquiring information related to a vehicle traveling in one area;
comparing the acquired information with past data in which the information and land price information are associated with each other for each area; and
estimating the land price information in the one area.

10. The program according to claim 9, wherein the information includes at least one of traveling information of the vehicle obtained in connection with driving of the vehicle, occupant information of an occupant of the vehicle, and vehicle type information of the vehicle.

11. The program according to claim 10, wherein the operations include:
acquiring the traveling information and position information of the vehicle that is associated with the traveling information; and
specifying a braking point where a brake is applied while the vehicle is traveling based on the acquired traveling information and position information.

12. The program according to claim 11, wherein the operations include:
further acquiring the occupant information associated with the traveling information and the position information; and
generating shop opening information of a shop to be opened adjacent to the specified braking point based on the acquired occupant information.

13. The program according to claim 10, wherein the operations include:
acquiring the traveling information and position information of the vehicle that is associated with the traveling information; and
estimating a point with a high probability of an accident in the one area based on the acquired traveling information and the position information.

14. The program according to claim 10, wherein the operations include:
acquiring the traveling information and position information of the vehicle that is associated with the traveling information; and
determining optimum route information related to life of a resident in the one area or a business activity of a business operator in the one area, based on the acquired traveling information and the position information.

15. A vehicle comprising a control unit that acquires information related to the vehicle traveling in one area and compares the acquired information with past data in which the information and land price information are associated with each other for each area so as to estimate the land price information in the one area.

16. The vehicle according to claim 15, wherein the information includes at least one of traveling information of the vehicle obtained in connection with driving of the vehicle, occupant information of an occupant of the vehicle, and vehicle type information of the vehicle.

17. The vehicle according to claim 16, wherein the control unit acquires the traveling information and position information of the vehicle that is associated with the traveling information, and specifies a braking point where a brake is applied while the vehicle is traveling based on the acquired traveling information and position information.

18. The vehicle according to claim 17, wherein the control unit further acquires the occupant information associated with the traveling information and the position information, and generates shop opening information of a shop to be opened adjacent to the specified braking point based on the acquired occupant information.

19. The vehicle according to claim 16, wherein the control unit acquires the traveling information and the position information of the vehicle that is associated with the traveling information, and estimates a point with a high probability of an accident in the one area based on the acquired traveling information and the position information.

20. The vehicle according to claim 16, wherein the control unit acquires the traveling information and the position information of the vehicle that is associated with the traveling information, and determines optimum route information related to life of a resident in the one area or a business activity of a business operator in the one area, based on the acquired traveling information and the position information.
